(19) United States
(12) Patent Application Publication
(10) Pub. No.: US 2010/0216093 A1
(43) Pub. Date: Aug. 26, 2010

(54) DENTAL IMPLANT

(76) Inventors: Victor Krush, Jerusalem (IL); Yuli Lozinski, Jerusalem (IL)

Correspondence Address: DANIEL J SWIRSKY, 55 REUVEN ST., BEIT SHEMESH, 99544, IL

(21) Appl. No.: 12/649,403

(22) Filed: Dec. 30, 2009

(30) Foreign Application Priority Data
Feb. 23, 2009 (IL) IL197178

(51) Int. Cl. A61C 8/00

(52) U.S. Cl. 433/174

(57) ABSTRACT

The invention provides a dental implant, characterized by a cylindrically threaded shaft section with at least a double lead thread. One lead thread is micro carved, while the other lead thread is carved with teeth of any shape, for instance V-shaped, buttress-shaped or square-shaped. The dimension of teeth increases gradually from zero in the lower part of the said implant (with constant or cone diameter) to approximately 0.1-0.2 of the diameter of the micro carving from the upper part of the said body implant. The maximal diameter of the said implant equals approximately 1.2-1.4 of that of the lower part. Thereto the internal body is supplied by a lead thread in order to block the said implant and may further be used for attachment of the key to turn in the said implant.

### CROSS-REFERENCE TO RELATED APPLICATIONS

This application claims priority benefit from Israel Patent Application No. 197178, filed Feb. 23, 2009, the contents of which are herein incorporated by reference in their entirety.

### FIELD OF THE INVENTION

The present invention relates to dental devices and more specifically to dental implant.

### BACKGROUND OF THE INVENTION

First, in order to install a dental implant, one needs to drill a hole in the bone in accordance to the design of the used implant. Several types of drills may be used, including those with a permanent, cone or increasing steps diameter.

Further, when the implant is turned in, carving is formed within the bone. Then, while the bone is healing it often sinks down, so that the implant projects over the bone edge. This leads to a total destruction of the thread made in the bone.

### SUMMARY OF THE INVENTION

The object of the present invention is to prevent the disadvantages of the before mentioned prior art dental devices and to provide a firm implant installation.

A dental implant comprises an unthreaded cylindrical portion and an elongated, externally threaded shaft section with at least a double lead thread, thereat one lead thread is micro carved and the other one is carved with teeth of any shape, for instance V-shaped, buttress-shaped or square-shaped, as the dimension of teeth increases gradually from zero in the lower part of the said implant (with constant or cone diameter) to approximately 0.1-0.2 of the diameter of the micro carving from the upper part of the said body implant and then the maximal diameter of the said implant equals approximately 1.2-1.4 of that of the lower part, thereto the internal body is supplied by a lead thread in order to block the said implant and may further be used for attachment of the key to turn in the said implant.

The dental implant may include two parts, the lower one is executed as described earlier and upper one may be executed with teeth, the size of which decreases gradually in accordance to the carving.

Moreover, the dental implant includes an antimicrobial.

### BRIEF DESCRIPTION OF THE DRAWINGS

The invention will now be described in connection with certain preferred embodiments with reference to the following illustrative figures so that it may be more fully understood. With specific reference now to the figures in details, it is stressed that the particulars figures shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more details than is necessary for a fundamental understanding of the invention. The description taken with the drawings making apparent to those skilled in the art how the several forms of the invention may be embodied in practice.

In the drawings:

FIG. 1 is a perspective view of an embodiment of a dental implant A with constant diameter in the oral environment.

FIG. 2 is an enlarged, cross-sectional view of the dental implant A.

FIG. 3 is a perspective view of an embodiment of a dental implant B with cone diameter in the oral environment.

FIG. 4 is a perspective view of another embodiment of a dental implant

### DETAILED DESCRIPTION OF THE INVENTION

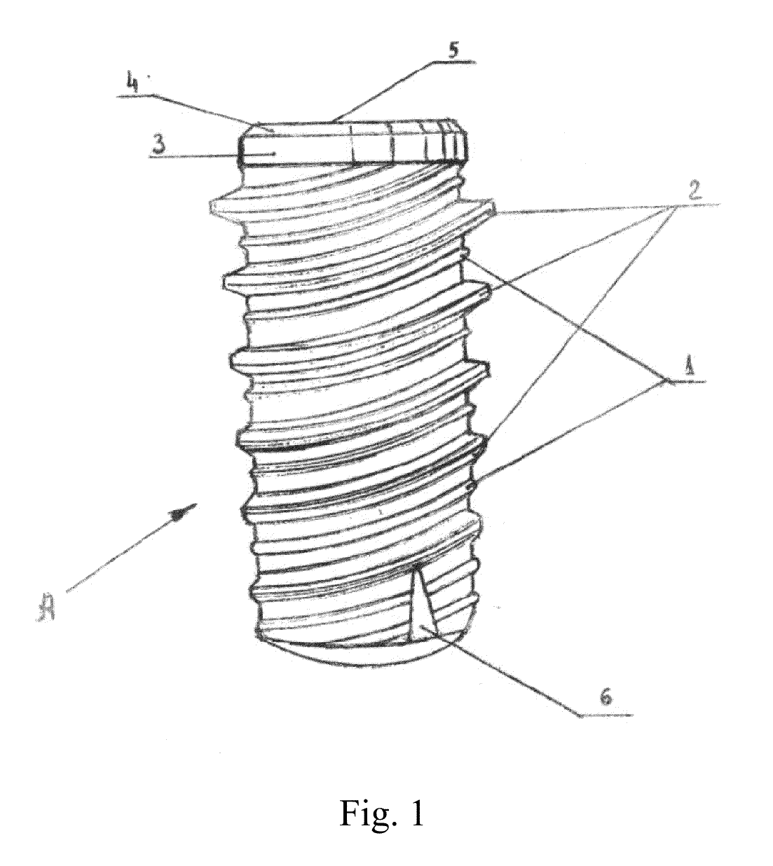

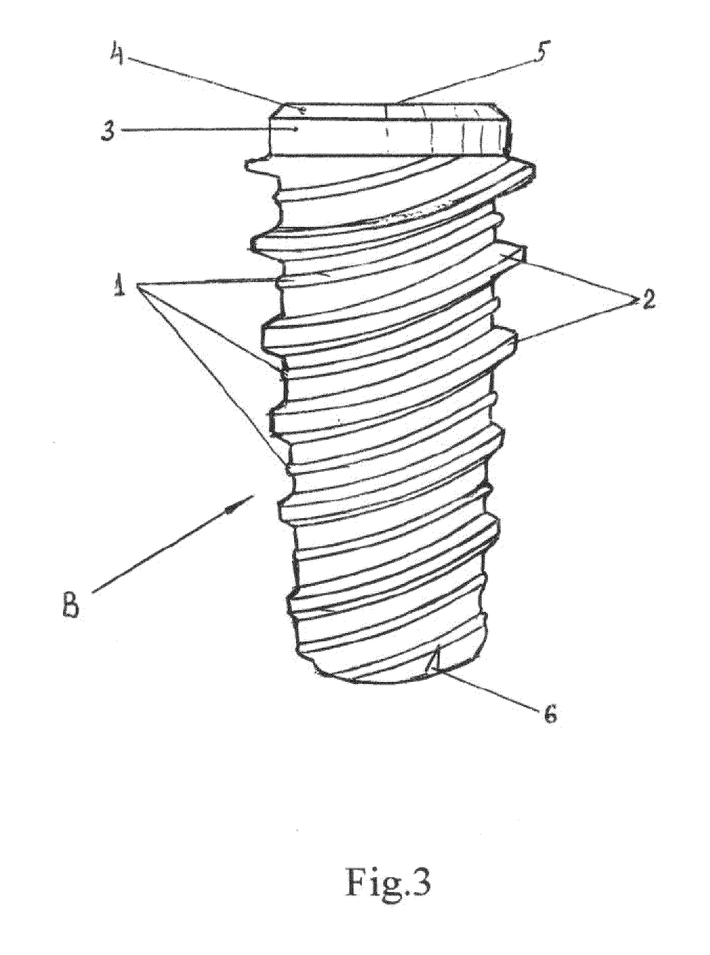

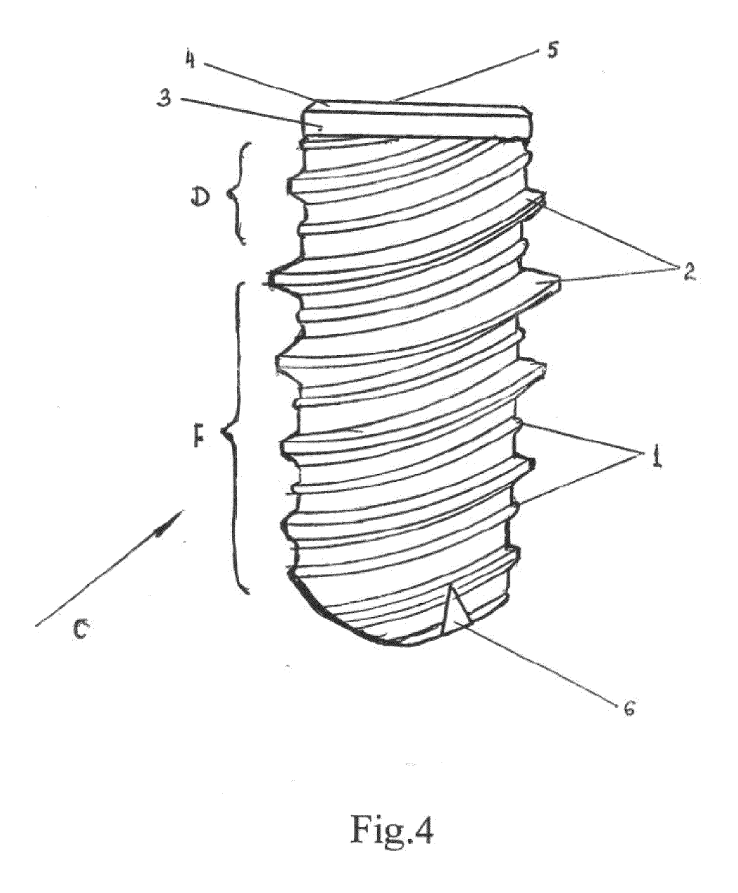

Referring to FIG. 1, there is an illustration of a commonly used prior art of dental implant A includes: 1-microcarved lead threads, 2-increasing value of teeth of the second lead threads, 3-untreaded cylindrical portion, 4-proximal untreaded portion, 5-flat surface atop dental implant, 6-antigingival growth barrier. (numbers of the FIG. 1 are corresponding numbers of the FIGS. 3 and 4)

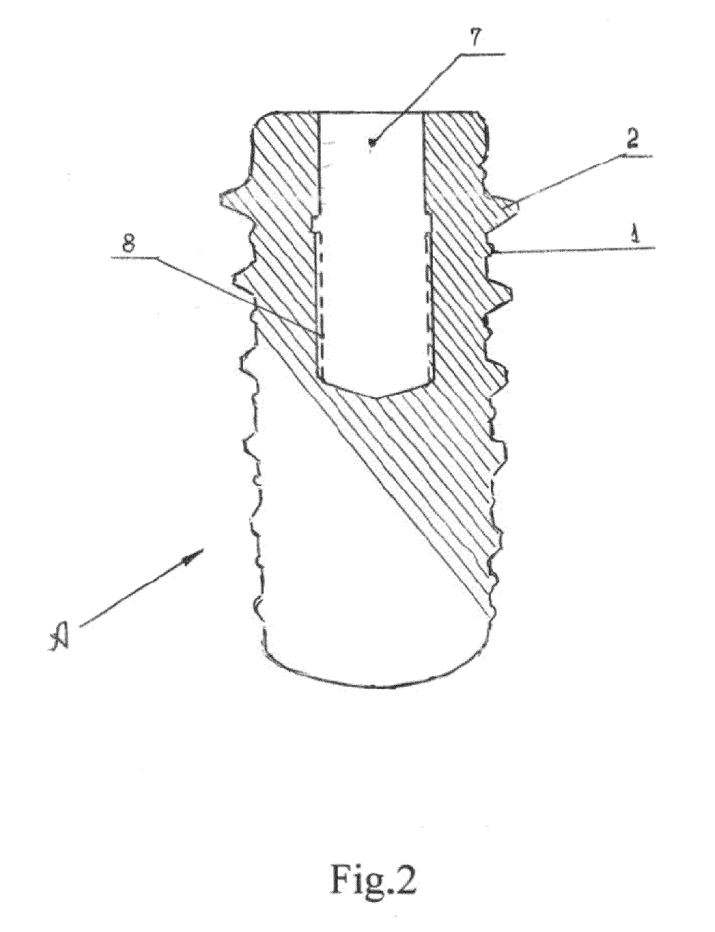

Referring to FIG. 2 shown cross-section of the said implant A, where 7-opening for block of the implant, 8-internal lead threads.

For instance, if the said implant has a micro carving diameter of 3,7 mm and a length 13 mm, then the maximal diameter of the second lead threads must be ≈ 4,5 mm. Thereat, first drill must have a diameter of 3,2 mm and a length (depth) of 13 mm, while the second drill must have a diameter of 3,7 mm and a length (depth) of 3 mm. Therefore, this construction permits to increase the surface of area of the implant and the loads put on the implant. This is especially important in those cases when alignment between the bone and the implant is absent (approximately 15-20 gradus). For dental implant shown in FIG. 3, the opening must be executed with cone drill angled according to the construction of the dental implant. For dental implant shown in FIG. 4, the opening must be executed with permanent drill with a diameter 3,2 mm.

In order to simplify the possible use of only one lead thread or instead micro carved teeth may be use two lead threads with teeth of any shape.

What is claimed is:

1. A dental implant comprising of an unthreaded cylindrical portion and an elongated, externally threaded shaft section with at least a double lead thread, thereat one lead thread is micro carved and the other one is carved with teeth of any shape, for instance V-shaped, buttress-shaped or square-shaped, as the dimension of teeth increases gradually from zero in the lower part of the said implant (with constant or cone diameter) to approximately 0.1-0.2 of the diameter of the micro carving from the upper part of the said body implant and then the maximal diameter of the said implant equals approximately 1.2-1.4 of that of the lower part, thereto the internal body is supplied by a lead thread in order to block the said implant and may further be used for attachment of the key to turn in the said implant.

2. The dental implant of the claim 1 includes two parts, the lower one is executed according to claim 1 and upper one may be executed with teeth, the size of which decreases gradually in accordance to the carving.

3. The dental implant of the claim 1, wherein may be use only one lead thread with carved of teeth of any shape.

4. The dental implant of the claim 1, wherein instead micro carved two lead threads have carved with teeth of any shape.

5. The dental implant of the claim 1, where said implant includes an antimicrobial.
